(19) United States
(12) Patent Application Publication
(10) Pub. No.: US 2022/0030937 A1
(43) Pub. Date: Feb. 3, 2022

(54) CATALYST INTRODUCTION METHODS FOR ACCELERATED DEACETYLATION OF CELLULOSE ESTERS

(71) Applicant: ACETATE INTERNATIONAL LLC, IRVING, TX (US)

(72) Inventors: Michael COMBS, Sandy Spring, VA (US); Cody PARKER, Redford, VA (US); Amber MILLER, Narrows, VA (US)

(21) Appl. No.: 17/443,649

(22) Filed: Jul. 27, 2021

Related U.S. Application Data
(60) Provisional application No. 63/058,197, filed on Jul. 29, 2020.

(51) Int. Cl. A24D 3/06; A24D 3/10; A24D 3/14; A24D 3/04; A24D 3/16; A24D 3/17; A24D 1/20

(52) U.S. Cl. CPC A24D 3/068; A24D 3/10; A24D 3/145; A24D 3/062; A24D 3/14; A24D 3/048; A24D 3/16; A24D 3/17; A24D 1/20; A24D 3/065

(57) ABSTRACT

Disclosed herein is a degradable cigarette filter comprising a cellulose ester and including a catalyst comprising a basic material, an enzymatic material, or combinations thereof. The catalyst, when exposed to water, may deacetylate the bloomed cellulose acetate tow by at least 10% in 20 days or less. The filters described herein therefore degrade more rapidly than other known cellulose acetate tow filters.

### CROSS REFERENCE TO RELATED APPLICATION

This application is a non-provisional of U.S. Provisional Application No. 63/058,197, filed on Jul. 29, 2020, the entire contents and disclosure of which is hereby incorporated by reference.

### FIELD OF THE INVENTION

The present invention relates generally to degradable cigarette filters comprising a cellulose ester and a basic material, an enzymatic material, or a combination of a basic material and an enzymatic material. In particular, the present invention relates to methods for incorporating a basic material, an enzymatic material, or combinations thereof into a cigarette filter comprising a cellulose ester.

### BACKGROUND OF THE INVENTION

Cellulose esters are widely used for many purposes, including in molded articles and as cellulose acetate tow in cigarette filters. Although cellulose esters such as cellulose acetate are biopolymers known to degrade, the rate of degradation is slower than natural cellulose. For example, cigarette filters may take up to 15 years to degrade because cellulose acetate does not degrade until sufficient acetyl groups have been removed, allowing for microorganisms to recognize the material for degradation. After smoking, the filters are often discarded in the environment and are one of the most common forms of man-made litter in the world. An estimated 4.5 trillion cigarette filters become litter each year. Due to the degradation time of cellulose acetate and to the plasticizer contained in the filter, the litter remains longer than desirable. Although attempts have been made to form biodegradable filters comprising cellulose acetate, these attempts have been unsuccessful for a variety of reasons, including an undesirable change to the taste of the cigarette due to modifications and/or additives and degradation time not being sufficiently reduced. Molded articles made of cellulose esters suffer from similar deficiencies.

U.S. Pat. No. 5,084,296, incorporated herein by reference, discloses a composition comprising a cellulose acetate or other cellulose ester, and an anatase-type titanium oxide having (1) a specific surface area of not less than 30 m²/g, (2) a primary particle size of 0.001 to 0.07 μm, or (3) a specific surface area of not less than 30 m2/g and a primary particle size of 0.001 to 0.07 μm. For improving the photodegradability and the dispersibility, the surface of the titanium oxide may be treated with a phosphoric acid salt or other phosphorus compound, a polyhydric alcohol, an amino acid or others. Use of a low-substituted cellulose ester with an average substitution degree not exceeding 2.15 insures high biodegradability. The composition may further contain a plasticizer and/or an aliphatic polyester, a biodegradation accelerator (e.g. organic acids or esters thereof). The degradable cellulose ester composition is highly photodegradable and moldable and hence useful for the manufacture of various articles.

U.S. Pat. No. 8,397,733, incorporated herein by reference, discloses a degradable cigarette filter which includes a filter element of a bloomed cellulose acetate tow and a plug wrap surrounding the filter element, and a pill dispersed in the tow. The pill includes a material adapted to catalyze hydrolysis of the cellulose acetate tow that is encapsulated with an inner layer of a water soluble or water permeable material and an outer layer of a cellulose acetate having a D.S. in the range of 2.0-2.6.

US Patent Publication No. 2009/0151738, incorporated herein by reference, discloses a degradable cigarette filter that includes a filter element of a bloomed cellulose acetate tow, a plug wrap surrounding the filter element, and either a coating or a pill in contact with the tow. The coating and/or pill may be composed of a material adapted to catalyze hydrolysis of the cellulose acetate tow and a water-soluble matrix material. The material may be an acid, an acid salt, a base, and/or a bacterium adapted to generate an acid. The coating may be applied to the tow, the plug wrap, or both. The pill may be placed in the filter element. When water contacts the water-soluble matrix material, the material adapted to catalyze hydrolysis is released and catalyzes the hydrolysis, and subsequent degradation, of the cellulose acetate tow. The foregoing is also applicable to articles made of cellulose esters.

Accordingly, there is a need for the controlled and sustained release of a material that will aid the degradation of cellulose esters used in cigarette filters.

### SUMMARY OF THE INVENTION

In some embodiments, the present disclosure is directed to a degradable cigarette filter comprising: a filter element comprising bloomed cellulose acetate tow, wherein the cellulose acetate has a degree of substitution (DS) of greater than 1.3; a catalyst comprising a basic material, an enzymatic material, or combination thereof and a plug wrap at least partially surrounding the filter element; wherein the catalyst is incorporated into at least one of the filter element, the plug wrap, or combinations thereof, and wherein the catalyst, when exposed to water, deacetylates the bloomed cellulose acetate tow by at least 10% in 20 days or less. The filter element may comprise a plurality of particles dispersed throughout the tow, wherein the particles comprise the catalyst. The particle size of the particles may range from 500 nanometers to 800 microns in size. The plug wrap of the cigarette filter may comprise the catalyst. The plug wrap may be impregnated with the catalyst, coated with the catalyst, or combinations thereof. The filter element may comprise a plurality of fibers impregnated with the catalyst, coated with the catalyst, or combinations thereof. The fibers may comprise polyvinyl alcohol, cellulose ether, polyethylene glycol, or combinations thereof. The filter element may comprise multiple segments wherein at least one of the segments comprises the catalyst. The segmented filter may have an encapsulated pressure drop of less than 3.5 mm water/mm length. The segment or segments comprising the catalyst may be in the shape of a hollow tube, a ring, or a perforated disk. The segment or segments comprising the catalyst may be impregnated with the catalyst, coated with the catalyst, or combinations thereof. The cigarette filter may further comprise a hard shell encasing the filter element, wherein the hard shell comprises the catalyst. The hard shell may comprise a thin wall right circular cylinder split across the diameter of the face. The hard shell may be impregnated with the catalyst, coated with the catalyst, or combinations thereof. The plug wrap of the cigarette filter may comprise a polymeric film. The polymeric film may comprise a binder. The polymeric film may comprise the catalyst. The polymeric film comprising the catalyst may be impregnated with the catalyst, coated with the catalyst, or combinations thereof. The basic material may have a pH of at least 7.4, preferably at least 7.6. The basic material may comprise at least one of calcium oxide, calcium hydroxide, magnesium hydroxide, magnesium oxide, magnesium carbonate, basic aluminum oxide, or combinations thereof. The catalyst may comprise a basic material and an enzymatic material, wherein the enzymatic material comprises an esterase, a cellulose, a glucosidase, or combinations thereof. The enzymatic material may comprise an esterase. The enzymatic material may comprise an esterase and at least one of a cellulase, a glucosidase, or combinations thereof. The catalyst, when exposed to water, may deacetylate the bloomed cellulose acetate tow by at least 20% in 20 days or less, preferably by at least 30%, more preferably by at least 60%.

In some embodiments, the present disclosure is directed to an aerosol-generating device comprising: an aerosol-generating article, wherein the aerosol-generating article comprises: an aerosol-forming substrate; a support element; an aerosol-cooling element; and a mouthpiece, wherein the mouthpiece comprises: a filter element comprising bloomed cellulose acetate tow, wherein the cellulose acetate has a degree of substitution (DS) of greater than 1.3; a catalyst comprising a basic material, an enzymatic material, or combination thereof; and a plug wrap at least partially surrounding the filter element, wherein the catalyst is incorporated into at least one of the filter element, the plug wrap, or combinations thereof, and wherein the catalyst, when exposed to water, deacetylates the bloomed cellulose acetate tow by at least 10% in 20 days or less.

In some embodiments, the present disclosure is directed to a tow bale comprising a plurality of cellulose acetate fibers and at least one fiber comprising a catalyst. The at least one fiber may be formed from a water-soluble fiber. The at least one fiber may be formed from a polyvinyl alcohol, a cellulose ether, a polyethylene glycol, a polyvinyl acetate, a polyvinyl pyrrolidone, a polylactic acid, a polybutylene succinate, a polyhydroxyalkanoate, or combinations thereof. The at least one fiber may have a fiber size from 1 to 100 to 100 to 1 relative to the size of a single cellulose acetate fiber of the plurality of cellulose acetate fibers.

### DESCRIPTION OF THE DRAWINGS

The present invention will be better understood in view of the appended, non-limiting figures, wherein:

FIG. 1 shows a degradable cigarette filter in accordance with embodiments of the present disclosure.

FIG. 2 shows another degradable cigarette filter in accordance with embodiments of the present disclosure.

FIG. 3 shows yet another degradable cigarette filter in accordance with embodiments of the present disclosure.

FIG. 3a shows a hollow tube of a degradable cigarette filter in accordance with embodiments of the present disclosure.

FIG. 4 shows a further degradable cigarette filter in accordance with embodiments of the present disclosure.

FIG. 4a shows a perforated disk of a degradable cigarette filter in accordance with embodiments of the present disclosure.

FIG. 5 shows another a degradable cigarette filter in accordance with embodiments of the present disclosure.

FIG. 5a shows a hard shell of a degradable cigarette filter in accordance with embodiments of the present disclosure.

### DETAILED DESCRIPTION OF THE INVENTION

### I. Introduction

The present disclosure is directed to degradable cigarette filters comprising cellulose acetate having a degree of substitution of greater than 1.3 and including a catalyst comprising a basic material, an enzymatic material, or combinations thereof. The cigarette filters include at least the catalyst, a filter element comprising the cellulose acetate, and a plug wrap at least partially surrounding the filter element. The catalyst may be incorporated into at least one of the filter element, the plug wrap, or combinations thereof. The catalyst, when exposed to water, is able to deacetylate the cellulose acetate by at least 10% in 20 days or less.

The present disclosure is further directed to embodiments of the degradable cigarette filter having the catalyst dispersed therein in various ways. An advantage of the catalyst dispersal arrangements described herein is that such arrangements allow the catalyst to be included in cigarette filters without requiring specialized manufacturing equipment (e.g., specialized filter rod makers and insertion equipment).

In addition to the partial degradation of at least 10%, the degradable tow, filters, and articles described herein have a total degradation value of over 80%, e.g., over 85%, over 90%, or even over 95%. Such a total degradation allows the cellulose acetate or other cellulose ester to degrade like cellulose, opening up possibilities for recycling the articles once they have been degraded to cellulose. Total degradation may be measured by measuring mg CO2 production according to ISO 19679 (2016).

The basic mechanism of cellulose ester degradation is dependent on the degree of substitution (“DS”) of the cellulose ester. DS of cellulose ester refers to the degree of substitution and may be measured, for example for cellulose acetate, by ASTM 871-96 (2010). When the cellulose acetate has a DS of greater than 1.3, cellulose acetate is not degraded by naturally occurring enzymes or bacteria due to the acetate moieties present. To replace the acetate moieties with hydroxyl moieties, and thereby reduce the DS, the cellulose acetate is hydrolyzed. Hydrolysis of the acetyl moieties is also referred to as deacetylation. The degradable cigarette filters described herein typically have a DS of greater than 1.3, often in the range of 2.0 to 2.6. The filters comprise a filter element comprising bloomed cellulose acetate tow, a catalyst dispersed in the bloomed cellulose acetate tow or a catalyst in contact with the bloomed cellulose acetate tow, and a plug wrap at least partially surrounding the filter element. The catalyst may comprise at least one of a basic material, an enzymatic material, or a combination thereof. In some embodiments, the catalyst may also comprise a water-soluble matrix material. The catalyst, when exposed to water, may deacetylate the bloomed cellulose acetate tow by at least 10% in 20 days or less. The filters described herein therefore degrade more rapidly than other known cellulose acetate tow filters.

### II. Cellulose Ester

As described herein, the present disclosure relates to including a catalyst (i.e., a basic material, an enzymatic material, or combinations thereof) in a cellulose ester, e.g., a cellulose acetate tow or a cigarette filter formed from cellulose acetate tow. The basic material, enzymatic material, or combination thereof is included with the cellulose ester in order to hydrolyze the cellulose ester and aid degradation. Cellulose acetate, as used herein, refers to cellulose diacetate, though the catalyst and methods described herein may be used for other types of cellulose esters, including cellulose triacetate, cellulose propionate, cellulose acetate-propionate, cellulose butyrate, cellulose acetate-butyrate, cellulose propionate-butyrate, cellulose nitrate, cellulose sulfate, cellulose phthalate and combinations thereof.

Cellulose esters may be prepared by known processes, including those disclosed in U.S. Pat. No. 2,740,775 and in U.S. Publication No. 2013/0096297, the entireties of which are incorporated herein by reference. Typically, acetylated cellulose is prepared by reacting cellulose with an acetylating agent in the presence of a suitable acidic catalyst and then de-esterifying.

The cellulose may be sourced from a variety of materials, including cotton linters, a softwood or from a hardwood. Softwood is a generic term typically used in reference to wood from conifers (i.e., needle-bearing trees from the order Pinales). Softwood-producing trees include pine, spruce, cedar, fir, larch, douglas-fir, hemlock, cypress, redwood and yew. Conversely, the term hardwood is typically used in reference to wood from broad-leaved or angiosperm trees. The terms “softwood” and “hardwood” do not necessarily describe the actual hardness of the wood. While, on average, hardwood is of higher density and hardness than softwood, there is considerable variation in actual wood hardness in both groups, and some softwood trees can actually produce wood that is harder than wood from hardwood trees. One feature separating hardwoods from softwoods is the presence of pores, or vessels, in hardwood trees, which are absent in softwood trees. On a microscopic level, softwood contains two types of cells, longitudinal wood fibers (or tracheids) and transverse ray cells. In softwood, water transport within the tree is via the tracheids rather than the pores of hardwoods. In some aspects, a hardwood cellulose is preferred for acetylating.

Acylating agents can include both carboxylic acid anhydrides (or simply anhydrides) and carboxylic acid halides, particularly carboxylic acid chlorides (or simply acid chlorides). Suitable acid chlorides can include, for example, acetyl chloride, propionyl chloride, butyryl chloride, benzoyl chloride and like acid chlorides. Suitable anhydrides can include, for example, acetic anhydride, propionic anhydride, butyric anhydride, benzoic anhydride and like anhydrides. Mixtures of these anhydrides or other acylating agents can also be used in order to introduce differing acyl groups to the cellulose. Mixed anhydrides such as, for example, acetic propionic anhydride, acetic butyric anhydride and the like can also be used for this purpose in some embodiments.

In most cases, the cellulose is exhaustively acetylated with the acetylating agent to produce a derivatized cellulose having a high degree of substitution (DS) value, such as from 2.4 to 3, along with some additional hydroxyl group substitution (e.g., sulfate esters) in some cases. Exhaustively acetylating the cellulose refers to an acetylation reaction that is driven toward completion such that as many hydroxyl groups as possible in cellulose undergo an acetylation reaction.

Suitable acidic catalysts for promoting the acetylation of cellulose often contain sulfuric acid or a mixture of sulfuric acid and at least one other acid. Other acidic catalysts not containing sulfuric acid can similarly be used to promote the acetylation reaction. In the case of sulfuric acid, at least some of the hydroxyl groups in the cellulose can become initially functionalized as sulfate esters during the acetylation reaction. Once exhaustively acetylated, the cellulose is then subjected to a controlled partial de-esterification step, generally in the presence of a de-esterification agent, also referred to as a controlled partial hydrolysis step.

De-esterification, as used herein, refers to a chemical reaction during which one or more of the ester groups of the intermediate cellulosic ester are cleaved from the cellulose acetate and replaced with a hydroxyl group, resulting in a cellulose acetate product having a (second) DS of less than 3. “De-esterifying agent,” as used herein, refers to a chemical agent capable of reacting with one or more of the ester groups of the cellulose acetate to form hydroxyl groups on the intermediate cellulosic ester. Suitable de-esterifying agents include low molecular weight alcohols, such as methanol, ethanol, isopropyl alcohol, pentanol, R—OH, wherein R is C1 to C20 alkyl group, and mixtures thereof. Water and a mixture of water and methanol may also be used as the de-esterifying agent. Typically, most of these sulfate esters are cleaved during the controlled partial hydrolysis used to reduce the amount of acetyl substitution. The reduced degree of substitution may range from 0.5 to 3.0, e.g., from 1.3 to 3, from 1.3 to 2.9, from 1.5 to 2.9 or from 2 to 2.6. For purposes of this disclosure, the degree of substitution is typically from 1.3 to 2.9 since below 1.3, natural degradation may occur. The degree of substitution may be selected based on the at least one organic solvent to be used in the binder composition. For example, when acetone is used as the organic solvent, the degree of substitution may range from 2.2 to 2.65.

The number average molecular weight of the cellulose ester may range from 30,000 Daltons (Da) to 100,000 Da, e.g., from 50,000 Da to 80,000 Da and may have a polydispersity from 1.5 to 2.5, e.g., from 1.75 to 2.25 or from 1.8 to 2.2. All molecular weight recited herein, unless otherwise specified, are number average molecular weights. The molecular weight may be selected based on the desired hardness of the final tow or filter rod. Although greater molecular weight leads to increased hardness, greater molecular weight also increases viscosity. The cellulose ester may be provided in powder or flake form.

In some aspects, blends of different molecular weight cellulose ester flake or powder may be used. Accordingly, a blend of high molecular weight cellulose ester, e.g., a cellulose ester having a molecular weight above 60,000 Da, may be blended with a low molecular weight cellulose ester, e.g., a cellulose ester having a molecular weight below 60,000 Da. The ratio of high molecular weight cellulose ester to low molecular weight cellulose ester may vary but may generally range from 1:10 to 10:1; e.g., from 1:5 to 5:1 or from 1:3 to 3:1. Blends of different cellulose esters may also be used and may include two, three, four, or more different cellulose esters in varied ratios. In some aspects, one cellulose ester may be present in a majority while other cellulose esters are present in smaller amounts.

### III. Cellulose Acetate Fibers, Tow, and Tow Bales

There are a number of methods of forming fibers from cellulose acetate which may be employed to form the cellulose acetate fibers of the present disclosure. In some embodiments, to form fibers from cellulose ester, a dope is formed by dissolving the cellulose ester in a solvent to form a dope solution. The dope solution is typically a highly viscous solution. The solvent of the dope solution may be selected from the group consisting of water, acetone, methylethyl ketone, methylene chloride, dioxane, dimethyl formamide, methanol, ethanol, glacial acetic acid, supercritical carbon dioxide, any suitable solvent capable of dissolving the aforementioned polymers, and combinations thereof. In some aspects, the solvent is acetone or a combination of acetone and up to 5 wt. % water. Pigments may also be added to the dope. The dope may comprise, for example, from 10 to 40 wt. % cellulose acetate and from 60 to 90 wt. % solvent. Pigments, when added, may be present from 0.1 to 5 wt. %, e.g., from 0.1 to 4 wt. %, from 0.1 to 3 wt. % from 0.1 to 2 wt. %, from 0.5 to 5 wt. %, from 0.5 to 4 wt. %, from 0.5 to 3 wt. %, from 0.5 to 2 wt. %, from 1 to 5 wt. %, from 1 to 4 wt. %, from 1 to 3 wt. % or from 1 to 2 wt. %. The dope is then filtered and deaerated prior to being spun to form fibers. The dope may be spun in a spinner comprising one or more cabinets, each cabinet comprising a spinneret. The spinneret comprises holes that affect the rate at which the solvent evaporates from the fibers.

The pigment added to the dope is not particularly limited, and any conventional pigment may be used. Examples of common, suitable pigments include calcium carbonate, diatomaceous earth, magnesium oxide, zinc oxide, and barium sulfate.

Generally, the production of a bale of tow bands may involve spinning fibers from the dope, forming a tow band from the fibers, crimping the tow band, and baling the crimped tow band. Within said production, optional steps may include, but are not limited to, warming the fibers after spinning, applying a finish or additive to the fibers and/or tow band prior to crimping, and conditioning the crimped tow band. The parameters of at least these steps are important for producing desirable bales.

It should be noted that bales may vary in size and shape as needed for further processing. In some embodiments, bales may have dimensions ranging from 30 inches (76 cm) to 60 inches (152 cm) in height, 46 inches (117 cm) to 56 inches (142 cm) in length, and 35 inches (89 cm) to 45 inches (114 cm) in width. In some embodiments, bales may range in weight from 900 pounds (408 kg) to 2100 pounds (953 kg). In some embodiments, bales may have a density greater than 300 kg/m3 (18.8 lb/ft3).

As described herein, the present disclosure includes tow bales formed from cellulose acetate fibers and at least one fiber comprising a catalyst. The at least one fiber comprising a catalyst may be incorporated into the tow bale by various means. For example, after extrusion of the fiber but prior to crimping, the at least one fiber may be incorporated into the tow band with the cellulose acetate fibers. The at least one fiber, described further herein, may have a similar or the same denier per filament as a cellulose acetate fiber, or may have a lesser or greater denier per filament. The at least one fiber may be a cellulose acetate fiber comprising catalyst, or may be a formed from a different material, such as a water-soluble fiber. Examples of the at least one fiber include polyvinyl alcohol, a cellulose ether, a polyethylene glycol, a polyvinyl acetate, a polyvinyl pyrrolidone, a polylactic acid, a polybutylene succinate, a polyhydroxyalkanoate, or combinations thereof. The at least one fiber may be present as one fiber, or may be a plurality of fibers. The at least one fiber may be in the center of the tow band, or may be dispersed throughout the tow band, either randomly or in a set position.

Fibers

The structure of the cellulose acetate fibers for use in the present disclosure is not particularly limited, and various known fiber structures may be employed. For example, the tow band may utilize fibers having a broad range of denier per filament (dpf). In some embodiments, the tow band has from 1 to 30 dpf, e.g., from 2 to 28 dpf, from 3 to 25 dpf, from 4 to 22 dpf, from 5 to 30 dpf, from 5 to 28 dpf, from 5 to 25 dpf, from 5 to 22 dpf, from 10 to 30 dpf, from 10 to 28 dpf, from 10 to 25 dpf, from 10 to 22 dpf, from 15 to 30 dpf, from 15 to 28 dpf, from 15 to 25 dpf, from 15 to 22 dpf, from 20 to 30 dpf, from 20 to 28 dpf, from 20 to 25 dpf, or from 20 to 22 dpf.

The fibers for use in the present disclosure may have any suitable cross-sectional shape, including, but not limited to, circular, substantially circular, crenulated, ovular, substantially ovular, polygonal, substantially polygonal, dog-bone, “Y,” “X,” “K,” “C,” multi-lobe, and any hybrid thereof. As used herein, the term “multi-lobe” refers to a cross-sectional shape having a point (not necessarily in the center of the cross-section) from which at least two lobes extend (not necessarily evenly spaced or evenly sized).

As noted above, fibers for use in the present disclosure may be produced by any method known to one skilled in the art. As noted, in some embodiments, fibers may be produced by spinning a dope through a spinneret. As used herein, the term “dope” refers to a cellulose acetate solution and/or suspension from which fibers are produced. In some embodiments, a dope may comprise cellulose acetate and solvents. In some embodiments, a dope for use in conjunction with the present disclosure may comprise cellulose acetate, solvents, and additives. In some embodiments, the cellulose acetate may be at a concentration in the dope ranging from 10 to 40 wt. percent (e.g., from 20 to 30 wt. %, from 25 to 40 wt. %, from 25 to 30 wt. %), and the solvent may be at a concentration from 60 to 90 wt. % (e.g., 60 to 80 wt. %, 70 to 80 wt. %, 80 to 90 wt. %). In some embodiments, the dope may be heated to a temperature ranging from 40° C. to 100° C. (e.g., from 45° C. to 95° C., from 50° C. to 90° C., from 55° C. to 85° C., from 60° C. to 80° C.).

Suitable solvents may include, but not be limited to, water, acetone, methylethyl ketone, methylene chloride, dioxane, dimethyl formamide, methanol, ethanol, glacial acetic acid, supercritical CO2, any suitable solvent capable of dissolving the aforementioned polymers, or any combination thereof. By way of nonlimiting example, a solvent for cellulose acetate may be an acetone/methanol mixture. In some embodiments, to produce very high dpf values of the present disclosure, increased solvent levels compared with amounts for typical dpf values (e.g., 2 to 8 dpf) may be used. For example in some embodiments, to produce very high dpf tow, solvent amounts may be from 5 to 30 wt. % greater when compared with solvent amounts for typical dpf tow. Additional solvent amounts may, in some cases, present challenges to the processing of the fibers.

Some embodiments of the present disclosure may involve treating fibers to achieve surface functionality on the fibers. In some embodiments, fibers may comprise a surface functionality including, but not limited to, biodegradability sites (e.g., defect sites to increase surface area to enhance biodegradability), chemical handles (e.g., carboxylic acid groups for subsequent functionalization), active particle binding sites (e.g., sulfide sites binding gold particles or chelating groups for binding iron oxide particles), sulfur moieties, or any combination thereof. One skilled in the art should understand the plurality of methods and mechanisms to achieve surface functionalities. Some embodiments may involve dipping, spraying, ionizing, functionalizing, acidizing, hydrolyzing, exposing to a plasma, exposing to an ionized gas, or any combination thereof to achieve surface functionalities. Suitable chemicals to impart a surface functionality may be any chemical or collection of chemicals capable of reacting with cellulose acetate including, but not limited to, acids (e.g., sulfuric acid, nitric acid, acetic acid, hydrofluoric acid, hydrochloric acid, and the like), reducing agents (e.g., LiAlH4, NaBH4, H2/Pt, and the like), Grignard reagents (e.g., CH3MgBr, and the like), trans-esterification reagent, amines (e.g., R—NH3 like CH3NH3), or any combination thereof. Exposure to plasmas and/or ionized gases may react with the surface, produce defects in the surface, or any combination thereof. Said defects may increase the surface area of the fibers which may yield higher loading and/or higher filtration efficacy in the final filter products.

Some embodiments of the present disclosure may involve applying a finish to the fibers. Suitable finishes may include, but not be limited to, at least one of the following: oils (e.g., mineral oils or liquid petroleum derivatives), water, additives, or any combination thereof. Examples of suitable mineral oils may include, but not be limited to, water white (i.e., clear) mineral oil having a viscosity of 80-95 SUS (Sabolt Universal Seconds) measured at 38° C. (100° F.). Examples of suitable emulsifiers may include, but not be limited to, sorbitan monolaurate, e.g., SPAN® 20 (available from Croda, Wilmington, Del.), poly(ethylene oxide) sorbitan monolaurate, e.g., TWEEN® 20 (available from Croda, Wilmington, Del.). The water may be de-mineralized water, de-ionized water, or otherwise appropriately filtered and treated water. The lubricant or finish may be applied by spraying or wiping. Generally, the lubricant or finish is added to the fiber prior to forming the fibers into tow.

In some embodiments of the present disclosure, finish may be applied as a neat finish or as a finish emulsion in water. As used herein, the term “neat finish” refers to a finish formulation without the addition of excess water. It should be noted that finish formulations may comprise water. In some embodiments, finish may be applied neat followed by applying water separately.

In some embodiments of the present disclosure, a finished emulsion may comprise less than 98% water, less than 95%, less than 92%, or less than 85%. In some embodiments, it may be advantageous in later steps to have fibers having a lower weight percentage of moisture (e.g., 5% to 25% w/w of the tow band), of which water is a contributor. The water content of the finished emulsion may be at least one parameter that may assist in achieving said weight percentage of moisture in the fibers. Therefore, in some embodiments, a finished emulsion may comprise less than 92% water, less than 85% water, or less than 75% water.

Tow

The present disclosure preferably includes forming tow bands from a plurality of fibers. In some embodiments, the tow band is from 10,000 to 100,000 total denier, e.g., from 15,000 to 100,000, from 20,000 to 100,000, from 25,000 to 100,000, from 30,000 to 100,000, from 10,000 to 90,000, from 15,000 to 90,000, from 20,000 to 90,000, from 25,000 to 90,000, from 30,000 to 90,000, from 10,000 to 90,000, from 15,000 to 90,000, from 20,000 to 90,000, from 25,000 to 90,000, from 30,000 to 90,000, from 10,000 to 80,000, from 15,000 to 80,000, from 20,000 to 80,000, from 25,000 to 80,000, from 30,000 to 80,000, from 10,000 to 70,000, from 15,000 to 70,000, from 20,000 to 70,000, from 25,000 to 70,000, from 30,000 to 70,000, from 10,000 to 60,000, from 15,000 to 60,000, from 20,000 to 60,000, from 25,000 to 60,000, or from 30,000 to 60,000. In terms of upper limits, the tow band may be less than 100,000 total denier, e.g., less than 90,000, less than 80,000, less than 70,000, or less than 60,000. In terms of lower limits, the tow band may be greater than 10,000 total denier, e.g., greater than 15,000, greater than 20,000, greater than 25,000, or greater than 30,000.

In some embodiments, the tow can have a breaking strength between 3.5 kg and 25 kg, e.g. from 3.5 kg to 22.5 kg, from 3.5 kg to 20 kg, from 3.5 kg to 17.5 kg, from 3.5 kg to 15 kg, from 4 kg to 25 kg, from 4 kg to 22.5 kg, from 4 kg to 20 kg, from 4 kg to 17.5 kg, from 4 kg to 15 kg, from 4.5 kg to 25 kg, from 4.5 kg to 22.5 kg, from 4.5 kg to 20 kg, from 4.5 kg to 17.5 kg, from 4.5 kg to 15 kg, from 5 kg to 25 kg, from 5 kg to 22.5 kg, from 5 kg to 20 kg, from 5 kg to 17.5 kg, or from 5 kg to 15 kg. In terms of upper limits, the tow may have a breaking strength of less than 25 kg, e.g., less than 22.5 kg, less than 20 kg, less than 17.5 kg, or less than 15 kg. In terms of lower limits, the tow may have a breaking strength of greater than 3.5 kg, e.g. greater than 4 kg, greater than 4.5 kg, or greater than 5 kg.

In some embodiments of the present disclosure, a tow band may comprise more than one type of fiber. In some embodiments, the more than one type of fiber may vary based on dpf, cross-sectional shape, composition, treatment prior to forming the tow band, or any combination thereof. Examples of suitable additional fibers may include, but are not limited to, carbon fibers, activated carbon fibers, natural fibers, synthetic fibers, or any combination thereof.

Some embodiments of the present disclosure may include crimping the tow band to form a crimped tow band. Crimping the tow band may involve using any suitable crimping technique known to those skilled in the art. These techniques may include a variety of apparatuses including, but not limited to, a stuffer box or a gear. Nonlimiting examples of crimping apparatuses and the mechanisms by which they work can be found in U.S. Pat. Nos. 7,610,852 and 7,585,441, the entire contents and disclosures of which are incorporated herein by reference. Suitable stuffer box crimpers may have smooth crimper nip rolls, threaded or grooved crimper nip rolls, textured crimper nip rolls, upper flaps, lower flaps, or any combination thereof.

The configuration of the crimp may play a role in the processability of the final bale. Examples of crimp configurations may include, but not be limited to, lateral, vertical, some degree between lateral and vertical, random, or any combination thereof. As used herein, the term “lateral” when describing crimp orientation refers to crimp or fiber bends in the plane of the tow band. As used herein, the term “vertical” when describing a crimp orientation refers to crimp projecting outside of the plane of the tow band and perpendicular to the plane of the tow band. It should be noted that the terms lateral and vertical refer to general overall crimp orientation and may have deviation from said configuration by +/−30 degrees.

In some embodiments of the present disclosure, a crimped tow band may comprise fibers with a first crimp configuration and fibers with a second crimp configuration.

In some embodiments of the present disclosure, a crimped tow band may comprise fibers with at least a vertical crimp configuration near the edges and fibers with at least a lateral crimp configuration near the center. In some embodiments, a crimped tow band may comprise fibers with a vertical crimp configuration near the edges and fibers with a lateral crimp configuration near the center.

The configuration of the crimp may be important for the processability of the final bale in subsequent processing steps, e.g., a lateral crimp configuration may provide better cohesion of fibers than a vertical crimp configuration unless further steps are taken to enhance cohesion. Methods for crimping tow bands with a substantially later crimp configuration are disclosed, for example, in U.S. Pub. No. 2013/0115452 and U.S. Pub. No. 2015/0128964, each of which is incorporated herein in its entirety.

In some embodiments of the present disclosure, the fibers may be adhered to each other to provide better processability of the final bale. While adhesion additives may be used in conjunction with any crimp configuration, it may be advantageous to use adhesion additives with a vertical crimp configuration. In some embodiments, adhering may involve adhesion additives on and/or in the fibers. Examples of such adhesion additives may include, but not be limited to, binders, adhesives, resins, tackifiers, or any combination thereof. It should be noted that any additive described herein, or otherwise, capable of adhering two fibers together may be used, which may include, but not be limited to, active particles, active compounds, ionic resins, zeolites, nanoparticles, ceramic particles, softening agents, plasticizers, pigments, dyes, flavorants, aromas, controlled release vesicles, surface modification agents, lubricating agents, emulsifiers, vitamins, peroxides, biocides, antifungals, antimicrobials, antistatic agents, flame retardants, antifoaming agents, degradation agents, conductivity modifying agents, stabilizing agents, or any combination thereof. Some embodiments of the present disclosure may involve adding adhesive additives to the fibers (in, on, or both) by incorporating the adhesive additives into the dope, incorporating the adhesive additives into the finish, applying the adhesive additives to the fibers (before, after, and/or during forming the tow band), applying the adhesive additives to the tow band (before, after, and/or during crimping), or any combination thereof.

Adhesive additives may be included in and/or on the fibers at a concentration sufficient to adhere the fibers together at a plurality of contact points to provide better processability of the final bale. The concentration of adhesive additives to use may depend on the type of adhesive additive and the strength of adhesion the adhesive additive provides. In some embodiments, the concentration of adhesive additive may range from a lower limit of 0.01%, 0.05%, 0.1%, or 0.25% to an upper limit of 5%, 2.5%, 1%, or 0.5% by weight of the tow band in the final bale. It should be noted that for additives that are used for more than adhesion, the concentration in the tow band in the final bale may be higher, e.g., 25% or less.

Further, some embodiments of the present disclosure may involve heating the fibers before, after, and/or during crimping. While said heating may be used in conjunction with any crimp configuration, it may be advantageous to use said heating with a vertical crimp configuration. Said heating may involve exposing the fibers of the tow band to steam, aerosolized compounds (e.g., plasticizers), liquids, heated fluids, direct heat sources, indirect heat sources, irradiation sources that causes additives in the fibers (e.g., nanoparticles) to produce heat, or any combination thereof.

Some embodiments of the present disclosure may include conditioning the crimped tow band. Conditioning may be used to achieve a crimped tow band having a residual acetone content of 0.5% or less w/w of the crimped tow band. Conditioning may be used to achieve a crimped tow band having a residual water content of 8% or less w/w of the crimped tow band. Conditioning may involve exposing the fibers of the crimped tow band to steam, aerosolized compounds (e.g., plasticizers), liquids, heated fluids, direct heat sources, indirect heat sources, irradiation sources that causes additives in the fibers (e.g., nanoparticles) to produce heat, or any combination thereof.

UCE is the amount of work required to uncrimp a fiber. UCE, as reported hereinafter, is sampled prior to baling, i.e., post-drying and pre-baling. UCE, as used herein, is measured as follows: using a warmed up (20 minutes before conventional calibration) Instron tensile tester (Model 1130, crosshead gears—Gear #'s R1940-1 and R940-2, Instron Series IX-Version 6 data acquisition & analysis software, Instron 50 Kg maximum capacity load cell, Instron top roller assembly, 1″×4″×⅛″ thick high grade Buna-N 70 Shore A durometer rubber grip faces), a preconditioned tow sample (preconditioned for 24 hours at 22° C.±2° C. and Relative humidity at 60%±2%) of about 76 cm in length is looped over and spread evenly across the center of the top roller, pre-tensioned by gently pulling to 100 g±2 g (per readout display), and each end of the sample is clamped (at the highest available pressure, but not exceeding the manufacturers recommendations) in the lower grips to effect a 50 cm gauge length (gauge length measured from top of the robber grips), and then tested, until break, at a crosshead speed of 30 cm/minute. This test is repeated until three acceptable tests are obtained and the average of the three data points from these tests is reported. Energy (E) limits are between 0.220 kg and 10.0 kg. Displacement (D) has a preset point of 10.0 kg. UCE is calculated by the formula: UCE (gcm/cm)=(E*1000)/((D*2)+500). Breaking strength can be calculated using the same test and the following equation BS=L (where L is the load at max load (kg)). In certain embodiments of the disclosure, UCE values (in gcm/cm) can range from 190 to 400, e.g., 200 to 300, e.g., 290. In certain embodiments of the disclosure breaking strength can range from between 3.5 kg and 25 kg, e.g. 4 kg to 20 kg, 4.5 kg to 15 kg, or 5 kg to 12 kg.

The catalyst described herein may be added to the cellulose acetate tow during rod making. For example, particles of the catalyst may be sprinkled on a running tow band on a rod making device. The catalyst may also be added to the cigarette filter during filter manufacture. For example, the filter plug wrap may be impregnated with the catalyst, coated with the catalyst, or combinations thereof. These embodiments, along with others, are discussed in more detail below.

### IV. Cigarette Filter

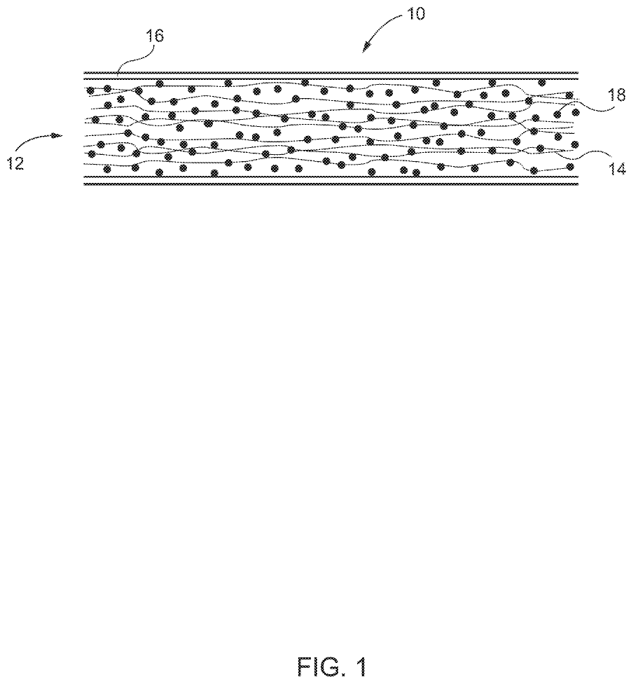

A degradable cigarette filter generally includes a filter element (or filter plug) made of a bloomed cellulose acetate tow, a plug wrap surrounding the filter element, and a catalyst. An example embodiment is shown in FIG. 1, wherein the filter 10 comprises a filter element 12 which comprises tow 14 and plug wrap 16 surrounding filter element 12.

A degradable cigarette filter, as used herein, refers to a cigarette filter that will decompose when exposed to an outdoor environment (i.e., exposed to rain, dew, or other sources of water). A catalyst, as used herein, comprises a material for catalyzing the hydrolysis of the cellulose acetate tow, i.e., a basic material, an enzymatic material, or combination thereof. In some embodiments, the catalyst may further comprise a water-soluble matrix material. In some embodiments, the catalyst may be added to the filter element during cigarette filter manufacture. In some embodiments, the catalyst may be added to the cellulose acetate tow during tow manufacture. In some aspects, the cigarette filter may be a specialty item which contains cellulose acetate in a form other than bloomed tow. The disclosure provided herein would also apply to such filters and the catalyst would be similarly included in the filter.

The weight, size, amount, and method of distribution of catalyst included in the filter may be determined by the desired rate of deacetylation of cellulose acetate in the tow and may also be chosen based on the filter type, e.g., microslims, superslims, and king size. Accordingly, the amount of the catalyst and the method used for its inclusion may be selected based on the mass of the filter size. The ratio of catalyst to tow, in terms of weight, may be from 1:50 to 1:1, e.g., from 1:25 to 1:2, or from 1:10 to 1:2.

### V. Catalyst

In order to aid the degradation of cellulose acetate, particularly cellulose acetate tow, a catalyst comprising a basic material, an enzymatic material, or combinations thereof is dispersed within the cigarette filter. The arrangement of catalyst within the cigarette filter can vary. In some embodiments, particles of the catalyst are dispersed throughout the tow (i.e., Dalmatian filter). In some embodiments, the filter plug wrap comprises the catalyst. In some embodiments, the filter element comprises fibers impregnated with the catalyst, coated with the catalyst, or combinations thereof. In some embodiments, the filter element comprises multiple segments and at least one of the segments comprises the catalyst. In some embodiments, the filter comprises a hard shell encasing the filter element, wherein the hard shell comprises the catalyst. Each of these embodiments will be discussed further below.

An advantage to the inclusion of a basic material or an enzymatic material as compared to an acidic material is the time needed to hydrolyze the acetate moieties. While acids can hydrolyze the acetate moieties, they are slower than basic or enzymatic materials. This relatively slower hydrolysis may be problematic when the cigarette filters are discarded in the environment. For example, if the filter is discarded in a puddle of water, or if a heavy rain storms hits, the acidic material may be washed out of the cellulose acetate tow and thus no acidic material would remain to catalyze degradation of the cellulose acetate. In contrast, the basic materials hydrolyze the cellulose acetate quickly when submersed in water, allowing for deacetylation before the basic material is washed out of the tow.

By including a basic or enzymatic material, particularly a material that is able to deacetylate the cellulose acetate tow or cellulose ester in the article, when exposed to water, by at least 10% in 20 days or less, the chances of the basic or enzymatic material washing out before they catalyze degradation are greatly reduced. As used herein, “when exposed to water” refers to the complete submersion of the tow containing the catalyst in water at room temperature, e.g., from 22 to 25° C. and standard pressure.

Additionally, by including a basic or enzymatic material as compared to an acidic material, the degraded cellulose acetate tow and any waste therefrom is closer to neutral than an acidic material. Without being bound by theory, it is believed that this occurs because unlike an acid catalyst, which protonates the carbonyl groups, the basic material is actually consumed. In some aspects, the basic material has an initial pH of greater than 7.4 and the cellulose acetate tow, after being deacetylated by the basic material, has a pH of less than 7.4, e.g., a pH of less than 7.3, less than 7.2, or less than 7.1. In terms of lower limits, the cellulose acetate tow, after being deacetylated by the basic material, has a pH of at least 6, e.g., at least 6.2, at least 6.4, at least 6.6, or at least 6.8. In some aspects, the basic material has an initial pH of greater than 7.6 and the tow, after being deacetylated by the basic material, as a pH of less than 7.4. In some further aspects, the pH decreases by at least 2 pH units. In some aspects, the pH of the cellulose acetate tow after being deacetylated, is approximately 7.

As used herein, the term “catalyst” refers to a composition comprising at least a basic material, an enzymatic material, or combinations thereof. In some embodiments, the catalyst can further comprise a water-soluble matrix material.

The basic material may comprise at least one of calcium carbonate, calcium oxide, calcium hydroxide, magnesium hydroxide, magnesium oxide, sodium phosphate, or combinations thereof. In some aspects, the basic material may comprise magnesium carbonate and/or basic aluminum oxide. The basic material may have a pH of at least greater than 7.0, e.g., at least 7.4, at least 7.5, at least 7.6, at least 7.7, at least 7.8, at least 7.9, or at least 8.0. In some aspects, the basic material may be a strong base such as calcium oxide, calcium hydroxide, or combinations thereof. Without being bound by theory, it is believed that when the catalyst comprises a strong base, the catalyst is dual action because it may hydrolyze the acetate moieties and cleave glycosidic bonds within the cellulose acetate tow.

The enzymatic material may comprise an esterase, a cellulase, a glucosidase, or combinations thereof. In some aspects, the esterase is a lipase. When the enzymatic material is included without any basic materials, an esterase is used. When the enzymatic material is included in addition to a basic material, then a cellulase, glucosidase, or combinations of cellulase, glucosidase, and esterase may be used. In some aspects, a combination of cellulases may be used, such as a combination of endo- and exo-cellulases.

In order to control the activation of the basic and/or enzymatic material in the catalyst, the catalyst may comprise a water-soluble matrix material, e.g., a coating based on a material other than cellulose acetate. The matrix material may have a water solubility of at least 0.01 g/100 mL at 25° C., e.g., at least 0.1 g/100 mL at 25° C., at least 0.5 g/100 mL at 25° C., at least 1.0 g/100 mL at 25° C. In some aspects, the matrix material comprises gelatin, polyethylene glycol, polylactic acid, polycaprolactone, polyvinyl pyrrolidone, polyvinyl alcohol or combinations thereof. In further aspects, the matrix material may comprise an oligosaccharide, a monosaccharide, a polyhydroxyalkanoate, or combinations thereof. The matrix material may comprise less than 1 wt. % cellulose acetate, less than 0.1 wt. % cellulose acetate, or may be free of cellulose acetate. In some aspects, the water solubility of the basic material may be less than the water solubility of the matrix material, e.g., at least 5% less, at least 10% less, or at least 25% less.

The catalyst, including any water-soluble matrix material, may comprise from 1 to 99 wt. % basic material, e.g., from 5 to 99 wt. %, from 10 to 90 wt. %, or from 25 to 75 wt. %. The catalyst may also contain other components, including fillers, flavorings, sweeteners, emulsifiers, disintegration aids, humectants, buggering agents, and mixtures thereof. These other components may make up the remainder of the weight of the catalyst, either alone or in combination with the basic material and/or enzymatic material described herein. In some aspects, the other components of the formulations may be artificial or may be obtained or derived from herbal or biological sources. Exemplary types of components that can be incorporated into one or more formulations according to the invention include salts such as sodium chloride, potassium chloride, sodium citrate, potassium citrate, sodium acetate, potassium acetate; natural sweeteners such as fructose, sucrose, glucose, maltose, vanillin, ethyl vanillin glycoside, mannose, galactose, and lactose; artificial sweeteners such as sucralose, saccharin, aspartame, acesulfame K, and neotame; organic and inorganic fillers such as grains, processed grains, swollen grains, maltodextrin, dextrose, calcium carbonate, calcium phosphate, corn starch, lactose, sugar alcohols such as isomalt, mannitol, xylitol, or sorbitol, cellulose finely divided, and vegetable protein; binders such as povidone, sodium carboxymethyl cellulose and other modified cellulosic types of binders, sodium alginate, xanthan gum, starch-based binders, gum arabic, gellan gum, and lecithin; gelling agents such as fish jelly pH adjusting agents or buffering agents such as metal hydroxides, including metal hydroxides alkalines such as sodium hydroxide and potassium hydroxide, and other alkali metal buffers such as metal carbonates, including potassium carbonate or sodium carbonate, or metal bicarbonates such as sodium bicarbonate; emulsifiers; dyes and pigments; humectants such as glycerin and propylene glycol; preservatives such as potassium sorbate; syrups such as honey and high fructose corn syrup; disintegration aids such as microcrystalline cellulose, croscarmellose sodium, crospovidone, sodium starch glycolate, and pregelatinized corn starch; flavoring and mixtures of flavorings, antioxidants, and mixtures thereof. Exemplary types of components may include those described in, for example, US Pub. No. 2010/0291245 which is incorporated herein by reference.

In aspects where the catalyst does not contain a basic material, the enzymatic material comprises an esterase in order to deacetylate the cellulose acetate. In aspects where the catalyst comprises a basic material, the catalyst may comprise an esterase, a cellulase, a glucosidase, or combinations thereof. The esterase may be included to deacetylate, or aid in the deacetylation of the cellulose acetate, while the cellulase, glucosidase, or combinations thereof may be included to degrade the cellulose acetate once the DS of the cellulose acetate is less than 1.3.

In some aspects, the catalyst deacetylates the cellulose acetate tow by at least 20% in 20 days or less, at least 30% in 20 days or less, at least 40% in 20 days or less, at least 50% in 20 days or less, or at least 60% in 20 days or less. In some aspects, the catalyst deacetylates the cellulose acetate tow by at least 20% in 10 days or less, at least 30% in 10 days or less, at least 40% in 10 days or less, at least 50% in 10 days or less, at least 60% in 10 days or less, at least 80% in 10 days or less, or at last 90% in 10 days or less. In some aspects, the catalyst deacetylates the cellulose acetate tow by at least 20% in 30 days or less, at least 40% in 30 days or less, at least 50% in 30 days or less, at least 60% in 30 days or less, at least 70% in 30 days or less, or at least 80% in 30 days or less. As used herein, deacetylation is measured by using ion chromatography with a conductivity detector measuring the acetate anion directly in an aqueous solution.

The catalyst can be included in the filter in a variety of ways, as described below.

Particle Dispersion

In some aspects, the filter element comprises a plurality of particles dispersed throughout the tow, wherein the particles comprise the catalyst. In one example, the particles comprising the catalyst can be sprinkled on a running tow band on a rod making machine as part of forming tow rods for filter. An example embodiment is illustrated in FIG. 1, wherein the filter 10 comprises a filter element 12 which comprises tow 14, plug wrap 16 surrounding the tow 14, and a plurality of particles 18 dispersed throughout the tow 14.

As used herein, the term “particle” refers to a solid material comprising the catalyst. The particles may range from a lower size limit in at least one dimension of at least 0.1 nanometers, 0.5 nanometers, 1 nanometer, 10 nanometers, 100 nanometers, 500 nanometers, 1 micron, 5 microns, 10 microns, 50 microns, 100 microns, 150 microns, 200 microns, or at least 250 microns. The active particles may range from an upper size limit in at least one dimension of less than 5000 microns, 2000 microns, 1000 microns, 900 microns, 700 microns, 500 microns, 400 microns, 300 microns, 250 microns, 200 microns, 150 microns, 100 microns, 50 microns, 10 microns, or 500 nanometers. Any combination of lower limits and upper limits above may be suitable for use in conjunction with the present invention, wherein the selected maximum size is greater than the selected minimum size. In some aspects, the particle size ranges from 0.1 nanometers to 5000 microns, e.g., from 0.5 nanometers to 2000 microns, from 1 nanometer to 1000 microns, from 10 microns to 1000 microns, from 100 microns to 1000 microns, or from 200 to 600 microns. In some aspects, the dalmatian style filter described herein has a particle size from 10 microns to 1000 microns, from 100 microns to 1000 microns, or from 200 to 600 microns. In some embodiments, the particles for use in conjunction with the present invention may be a mixture of particle sizes ranging from the above lower and upper limits. In some embodiments of the present invention, the size of the particles may be polymodal.

Plug Wrap

In some aspects, the plug wrap comprises the catalyst. In some aspects, the plug wrap is impregnated with the catalyst. The typical paper filler could be substituted for the catalyst, such as substitution CaO for CaCO₃. In another aspect, the paper filler of the plug wrap may comprise a blend of CaO and CaCO₃. Increased porosity as catalyst dissolves further improves degradation by improving microbial access. In some embodiments, the plug wrap is coated with the catalyst. For example, the catalyst may be coated (glued or otherwise applied) as a line on an inside surface of the plug wrap, such as when forming the tow rod. In another aspect, the catalyst may be coated onto the plug wrap via a spool that feeds the catalyst onto the plug wrap during the rod making process. The catalyst may also be applied as a continuous coating on the inner and/or or outer surface of the plug wrap, such as in a honeycomb configuration. In a preferred embodiment, the coating is on the inner surface (i.e., in contact with the filter element comprising the cellulose acetate tow). In some embodiments, the plug wrap is impregnated with the catalyst and coated with the catalyst.

In some aspects, the plug wrap comprises a polymeric film as described in U.S. patent publication number 2018/0310624, incorporated herein by reference. In some embodiments, the polymeric film comprises cellulose acetate. The film may be impregnated and/or coated with catalyst. In some embodiments, the cellulose acetate film further comprises a water-soluble binder.

The cellulose acetate described herein may be prepared as a film and used as a component of a cigarette filter. In some embodiments, the film is used as a plug wrap. Cellulose acetate cannot be processed as a raw material because its decomposition temperature is lower than melt-processing temperatures. One solution to this problem is to use plasticizers. Combining a plasticizer with cellulose acetate reduces interactions between segments of the cellulose acetate polymer chain and reduces the glass transition temperature, melt viscosity and elastic modulus of the cellulose acetate, making the plasticized cellulose acetate melt processable.

Generally, the cellulose acetate film comprises from 55 to 99.5 wt. % cellulose acetate, based on the total weight of the film, e.g., from 60 to 95 wt. %, from 65 to 90 wt. %, or from 70 to 85 wt. %. The cellulose acetate film also comprises a plasticizer and may comprise a processing aid, and/or a releasing agent. In some aspects, the cellulose acetate film may comprise a blend of cellulose acetate and polylactic acid.

The plasticizer may be present from 0.5 to 40 wt. % based on the total weight of the film, e.g., from 1 to 35 wt. %, from 5 to 30 wt. %, or from 10 to 25 wt. %. The percentage of plasticizer may vary depending on the method by which the cellulose acetate film is formed. Generally, a greater weight percentage of plasticizer is used to form the film by melt extrusion as compared to solvent casting, e.g., from 15 to 40 wt. %, from 20 to 40 wt. %, or from 25 to 35 wt. % for melt extrusion and from 0.5 to 25 wt. %, e.g., from 1 to 25 wt. %, from 5 to 25 wt. %, or from 10 to 25 wt. % for solvent casting.

Although a wide variety of plasticizers are known for plasticizing cellulose acetate, including those described in US Pub. No. 2015/0351311, a food grade plasticizer is preferred since numerous classic plasticizers are explicitly prohibited from use in cigarettes, whether traditional or heated. For example, phthalates, phosphorus, and chlorinated plasticizers may be prohibited. As used herein, the term “food grade” refers to a material that has been approved for contacting (directly or indirectly) food, which may be classified as based on the material's conformity to the requirements of the United States Pharmacopeia (“USP-grade”), the National Formulary (“NF-grade”), and/or the Food Chemicals Codex (“FCC-grade”) as of Apr. 30, 2017. Food grade plasticizers include triacetin, diacetin, tripropionin, trimethyl citrate, triethyl citrate, tributyl citrate, eugenol, cinnamyl alcohol, alkyl lactones (e.g., γ-valerolactone), methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, polyethoxylated fatty alcohols, and combinations thereof. In further embodiments, the plasticizer is triacetin. In still further aspects, the plasticizer does not contain a phthalate (is “phthalate-free”).

As discussed, the film also optionally comprises a processing aid. When included, the processing aid may be present in an amount from 0.05 to 10 wt. % based on the total weight of the film, e.g., from 0.1 to 5 wt. %, or from 0.5 to 2.5 wt. %. The processing aid may be selected from the group consisting of titanium dioxide, aluminum oxide, zirconium oxide, silicon dioxide, calcium carbonate, calcium silicate, aluminum silicate, magnesium silicate, calcium phosphate and mixtures thereof. In some embodiments, the processing aid is silica. The average particle size of the processing aid may vary. In some aspects, the processing aid may have an average particle size from 0.01 to 50 μm, e.g., from 0.02 microns to 40 microns, from, from 0.05 microns to 30 microns. The particle size may be determined, for example, by sieve analysis.

A releasing agent may also be included in order to improve releasability of the film, once formed, from a backing sheet or substrate. When included, the releasing agent may be present from 0.01 to 10 wt. % based on the total weight of the film, e.g., from 0.05 to 5 wt. %, from 0.05 to 1 wt. %, or from 0.05 to 0.5 wt. %. The releasing agent is generally included when the film is solvent cast, and is added to the dope. In some embodiments, the releasing agent is a fatty acid, such as stearic acid.

The film may have a thickness from 14 to 700 μm, e.g., from 14 to 150 μm or from 20 to 75 μm. As the thickness of the film is decreased, the heat management of the film improves and the cost decreases. Again, because of the relative flexibility of the cellulose acetate film, especially as compared to a polylactic acid film, the cellulose acetate film may be thin, e.g., less than 50 μm. The thinner the film, the more processing aid may be used.

The film may be glossy or matte, as determined by visual inspection and by standard 20, 60 and 85° measurements. In some aspects, the film is matte. Without being bound by theory, it is believed that the surface area of the film is increased when the film is matte, allowing for improved cooling. In some embodiments, additional components may be added to the film. Such components include a matting agent, though such agent is not necessary to provide a matte film. In some aspects, the matte surface is imparted by the casting or extrusion process. In other aspects, an embossing roller may be used.

The cellulose acetate film may be prepared by one of two general methods: melt extrusion or solvent casting, each of which is described below.

a. Melt Extrusion

For melt extrusion, a mixture of cellulose acetate, a plasticizer, and any optional components, such as a processing aid, are combined. The mixture may be formed by combining cellulose acetate, in flake or powder form, with the plasticizer and optional processing aid. In some embodiments, the plasticizer and optional processing aid may be combined with the cellulose acetate using a spray distribution system during the mixing step. In other embodiments, the plasticizer and optional processing aid may be added to the cellulose acetate during the mixing step, either continuously or intermittently. In some embodiments, the powder form of cellulose acetate is preferred while in other embodiments cellulose acetate flake may be used. Without being bound by theory, it is believed that the powder form may lead to a sheet with improved plasticization and uniformity as compared to the flake form.

After forming the mixture comprising cellulose acetate, plasticizer and optional processing aid, the mixture may be melt extruded in a small hole die to form filaments which are then sent to a pelletizer to form pellets. The melt extrusion may be performed at a temperature from 165 to 230° C., e.g., from 165 to 220° C. or from 165 to 210° C. The melt extruder may be a twin screw feeder with co-rotating screws, and may be operated at a screw speed from 100 to 500 rpm, e.g., from 150 to 450 rpm, or from 250 to 350 rpm. The pellets may then be extruded to form a film. The film may then be dried. Once dried, the film may then be crimped using a crimper.

b. Solvent Casting

Processes for preparing cellulose acetate films by solvent casting have been described in U.S. Pat. Nos. 2,232,012 and 3,528,833, the entireties of which are incorporated by reference herein. In general, the solvent casting process comprises casting a mixture, also referred to as a dope, comprising plasticizer, processing aid, releasing agent, and cellulose acetate dissolved in a solvent, e.g., acetone. The components of the mixture and the respective amounts determine the characteristics of the film, which is discussed herein.

The dope may be prepared by dissolving cellulose acetate in a solvent. In some embodiments, the solvent is acetone. In one embodiment, the solvent is selected from the group consisting of ethyl lactate methyl ethyl ketone, and dichloromethane. To improve the solubility of cellulose acetate in acetone, the cellulose acetate and acetone may be continuously added to a first mixer. The mixture may then be sent to a second and/or third mixer to allow for full dissolution of the cellulose acetate in the acetone. The mixers may be continuous mixers that are used in series. It is understood that in some embodiments, one mixer may be sufficient to achieve cellulose acetate dissolution. In other embodiments, two, three, or more mixers (e.g., four mixers, five mixers, or greater than five mixers) may be used in series or in parallel. In yet other embodiments, the cellulose acetate, solvent, and other additives may be combined in one or more blenders, without the use of any mixers.

The dope may then be cast on a casting band and dried to evaporate the solvent to prepare a film. The inclusion of a releasing agent improves the release of the film from the casting band. The film may dried and crimped as described above.

Fibers

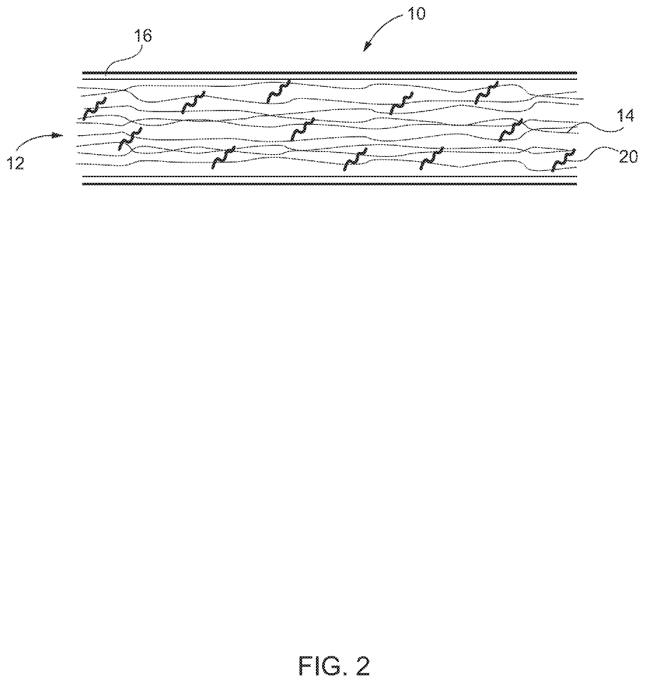

In some aspects, the filter element comprises, in addition to the bloomed cellulose acetate tow, a plurality of fibers impregnated with the catalyst, coated with the catalyst, or combinations thereof. In some embodiments, the fibers comprise a polyvinyl alcohol, a cellulose ether, a polyethylene glycol, a polyvinyl acetate, a polyvinyl pyrrolidone, a polylactic acid, a polybutylene succinate, a polyhydroxyalkanoate, or combinations thereof. In some aspects, a water-soluble polymer may be included to aid in the solids loading process of a filament. In one embodiment, the fibers may be added to the cellulose acetate tow during tow band formation or while blooming the tow. In another embodiment, the fibers may be added to the filter element during filter rod manufacture. An example embodiment is illustrated in FIG. 2, wherein the filter 10 comprises a filter element 12 which comprises tow 14, plug wrap 16 surrounding the tow 14, and a plurality of fibers 20 dispersed throughout the tow 14.

The fibers comprising the catalyst may be present in the filter element from 0.1 to 20 wt. % based on the total weight of the cellulose acetate tow and fibers, e.g., from 0.5 to 18 wt. %, from 3 to 15 wt. %, or from 5 to 10 wt. %. The number of fibers and wt. % included in the filter element may vary based on the characteristics of the filter element, e.g., diameter and shape, or on characteristics of the catalyst, e.g., catalyst type and amount necessary for desired degradation. In some embodiments, the number of fibers and wt. % included in the filter is determined based on maintaining an encapsulated pressure drop of less than or equal to 3.5 mm water/mm length, e.g., less than 3.2 mm water/mm length, less than 3.0 mm water/mm length, less than 2.8 mm water/mm length, less than 2.5 mm water/mm length, or less than 2.2 mm water/mm length. In terms or ranges, the encapsulated pressure drop may range from 1.0 to 3.5 mm water/mm length, e.g., from 1.2 to 3.2 mm water/mm length, from 1.5 to 3 mm water/mm length, or from 1.8 to 2.8 mm water/mm length. In some aspects, the encapsulated pressure drop of the filter with the catalyst changes by less than 20% as compared to the same filter without the catalyst, e.g., less than 15%, less than 10%, or less than 5%, or less than 1% (i.e., does not substantially change). The size of the fiber may be determined relative to the size of the cellulose acetate fibers, such as from 1:100 to 100:1 in a size ratio of fiber to cellulose acetate fiber, e.g., from 1:50 to 50:1, from 1:25 to 25:1, from 1:10 to 10:1, from 1:5 to 5:1, from 1:3 to 3:1, or approximately 1:1. In some aspects, the at least one fiber is a single fiber. In other aspects, the at least one fiber is a plurality of fibers, distributed evenly throughout the tow or clustered in a specific area of the tow, such as the center,

Segmented Filter

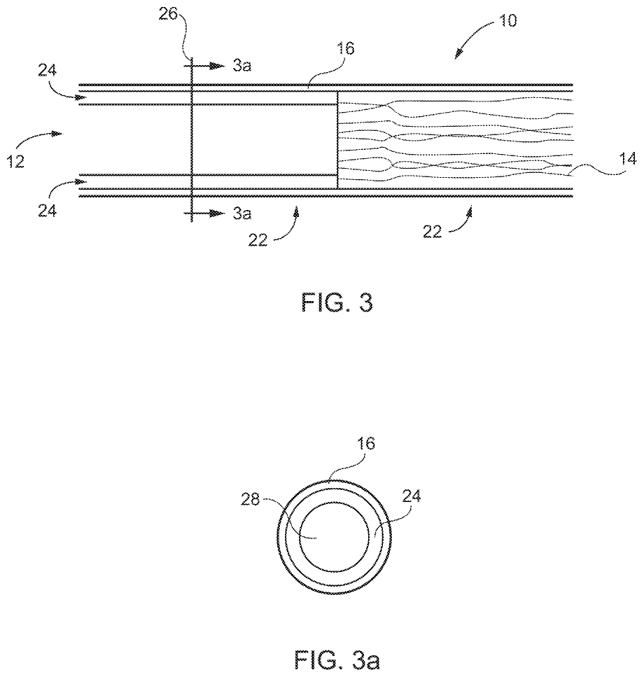

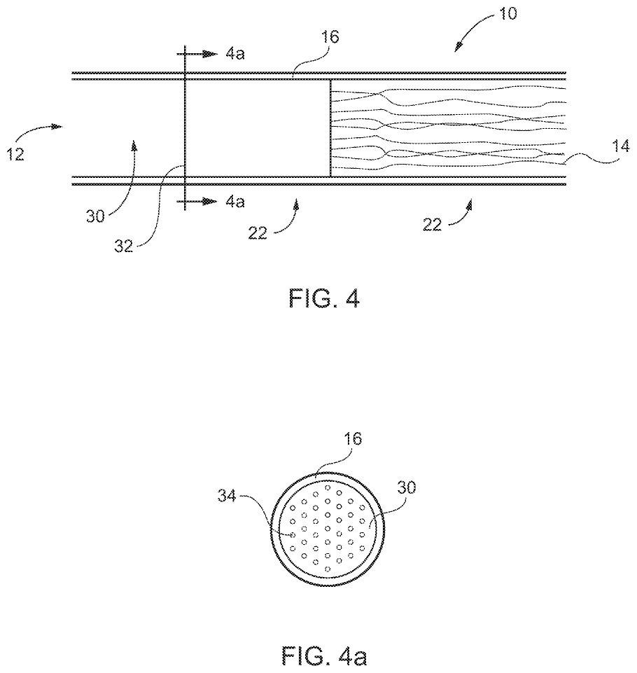

In some aspects, the filter element comprises multiple filter segments, wherein at least one of the segments comprises the catalyst. The segment may be impregnated with the catalyst, coated with the catalyst, or combinations thereof. The segment comprising the catalyst may comprise a material other than cellulose acetate. For example, the segment may comprise a water-soluble matrix material as described above. In some embodiments, the segment comprising the catalyst is shaped so as to let smoke pass through. In one embodiment, as illustrated in FIG. 3, the segment comprising the catalyst is a hollow tube. FIG. 3 shows a filter 10 comprising a filter element 12 which comprises multiple segments 22. One segment comprises tow 14, and a second segment is a hollow tube 24. The plug wrap 16 surrounds the multiple segments 22. In FIG. 3a, the hollow tube 24 is visible when the filter element is cut along cut lines 26. The hollow space 28 allows smoke to pass through the filter segment 22 comprising the hollow tube 24. In one embodiment, the segment comprising the catalyst is a ring. In one embodiment, as illustrated in FIG. 4, the segment comprising the catalyst is a perforated disk. FIG. 4 shows a filter 10 comprising a filter element 12 which comprises multiple segments 22. One segment comprises tow 14, and a second segment is a perforated disk 30. The plug wrap 16 surrounds the multiple segments 22. In FIG. 4a, the perforated disk 30 is visible when the filter element is cut along cut lines 32. The perforations 34 allow smoke to pass through the filter segment 22 comprising the perforated disk 30. In some aspects, the tube need not be completely hollow but can be a porous structure that allows for sufficient air permeability without negatively affecting pressure drop.

Filter Element Shell

In some aspects, the filter element further comprises a hard shell encasing the filter element, wherein the hard shell comprises the catalyst. In some embodiments, the hard shell comprises a thin wall right circular cylinder split across the diameter of the face into two pieces. These pieces can be sandwiched around the filter element prior to addition of the plug wrap, such that the plug wrap contains the filter element and the hard shell. In some embodiments, the hard shell is impregnated with the catalyst, coated with the catalyst, or combinations thereof. The shell may comprise a material other than cellulose acetate. For example, the shell may comprise a water-soluble matrix material as described above.

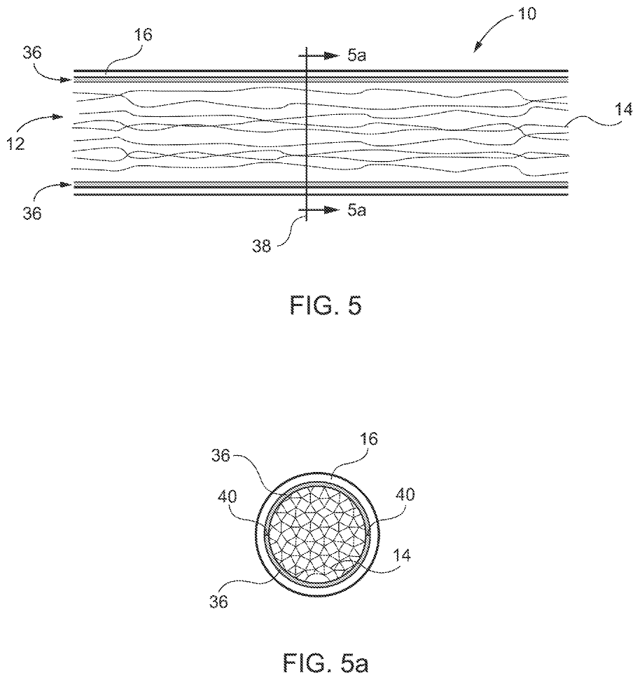

In one embodiment, as illustrated in FIG. 5, the filter 10 comprises a filter element 12 which comprises tow 14, a hard shell 36 surrounding the tow 14, and a plug wrap 16 surrounding the hard shell 36. In FIG. 5a, the hard shell 36 is visible when the filter element is cut along cut lines 38. The two pieces of the hard shell 36 are visible, joined together at joining lines 40.

The present disclosure will be better understood in view of the following non-limiting examples.

### EXAMPLES

### Example 1

In order to determine the deacetylation rate of cellulose acetate depending on various catalytic materials, cellulose acetate tow having a DS of 2.5, was prepared and formed into rods. The rods also contained 8 wt. % triacetin as plasticizer. The weight of each rod was approximately 0.15 grams. Each rod was then placed into approximately 4 milliliters of deionized water. In all samples except Comparative Sample A, shown below, approximately 50 milligrams of the catalytic material was added to the water. After three days and after 38 days, the pH was measured. The percentage of deacetylation was measured by removing a sample of the cellulose acetate tow and using high performance liquid chromatography (HPLC). The results are shown below.

TABLE 1

| | Catalytic Material | pH Day 1 | pH Day 38 |
|---|---|---|---|
| Comp. | — | 6.5 | 6.0 |
| Sample A | | | |
| Comp. | Citric Acid | 2.0 | 2.0 |
| Sample B | | | |
| Sample 1 | Magnesium Oxide | 9.0 | 6.5 |
| Sample 2 | Magnesium | 8.0 | 7.0 |
| | Hydroxide | | |
| | | pH Day 1 | pH Day 35 |
| Sample 3 | Calcium Oxide | 11.0 | 9.0 |
| Sample 4 | Calcium Hydroxide | 11.0 | 7.0 |
| | | pH Day 1 | pH Day 21 |
| Comp. | Sodium Phosphate | 10.0 | 8.0 |
| Sample C | | | |

TABLE 2

| | Percent of Deacetylation (%) | | | | | | | |
|---|---|---|---|---|---|---|---|---|
| | Day 4 | Day 6 | Day 10 | Day 12 | Day 14 | Day 19 | Day 31 | Day 38 |
| Comp. | 7.80 | 8.09 | 8.27 | 8.36 | 8.28 | 8.84 | 8.85 | 9.93 |
| Sample A | | | | | | | | |
| Comp. | 1.52 | 1.67 | 2.28 | 2.63 | 2.96 | 3.83 | 5.36 | 5.88 |
| Sample B | | | | | | | | |
| Sample 1 | 11.62 | 14.41 | 17.59 | 19.48 | 21.54 | 27.04 | 47.26 | 43.02 |
| Sample 2 | 10.18 | 10.93 | 12.60 | 12.34 | 13.46 | 14.65 | 18.85 | 20.01 |
| | Day 1 | Day 3 | Day 7 | Day 9 | Day 11 | Day 16 | Day 28 | Day 35 |
| Sample 3 | 83.87 | >100 | >100 | >100 | >100 | >100 | >100 | >100 |
| Sample 4 | 67.79 | 94.58 | >100 | >100 | >100 | 73.19 | 81.34 | >100 |
| | Day 1 | | Day 3 | Day 7 | | Day 14 | Day 21 | |
| Comp. | 25.05 | | 26.70 | 29.04 | | 27.21 | 28.81 | |
| Sample C | | | | | | | | |

The rate of deacetylation is important because, as described herein, the acetyl moieties of cellulose acetate must be replaced with hydroxyl moieties in order for natural degradation to occur. As shown above, Comparative Sample A, which did not include catalytic material, only had a 9.93% deacetylation after 38 days. Comparative Sample B, which included citric acid as the catalytic material, surprisingly performed worse than Comparative Sample A. Samples 1 and 2 performed well and showed more deacetylation at Day 4 than Comparative Samples A and B at Day 38. Samples 3 and 4 had the best performance, reaching full or nearly full deacetylation by Day 3. Although the deacetylation for Samples 3 and 4 includes values above 100%, it is believed that these values were due to the assumption of 8 wt. % triacetin.

### Example 2

In order to determine the deacetylation rate of cellulose acetate in a cigarette filter that has been smoked, depending on various materials, cellulose acetate tow rods were prepared as above, except that they had a filter rod weight of approximately 0.24 grams. The plasticizer and catalyst were the same as in Example 1. The basic material was also as in Example 1. The measurements were taken as in Example 1. The results are shown below.

TABLE 3

| | Catalytic Material | pH Day 1 | pH Day 21 |
|---|---|---|---|
| Comp. | — | 7.5 | 6.5 |
| Sample D | | | |
| Comp. | Citric Acid | 4.0 | 4.0 |
| Sample E | | | (Day 15) |
| Sample 5 | Calcium Oxide | 11.0 | 8.0 |
| Sample 6 | Calcium Hydroxide | 11.0 | 7.0 |
| Sample 7 | Magnesium Oxide | 9.0 | 7.5 |
| Comp. | Calcium Carbonate | 7.5 | 6.5 |
| Sample F | | | |

TABLE 4

| | Percent of Deacetylation (%) | | | | |
|---|---|---|---|---|---|
| | Day 1 | Day 3 | Day 7 | Day 14 | Day 21 |
| Comp. Sample D | 6.21 | 7.23 | 7.66 | 9.18 | 9.31 |
| Comp. Sample E | 4.3 | 4.38 | 4.39 | 4.58 | 5.90 |
| | | | (Day 6) | (Day 8) | (Day 15) |
| Sample 5 | 33.24 | 77.63 | 88.44 | 88.42 | 92.30 |
| Sample 6 | 30.09 | 42.20 | 43.55 | 46.72 | 50.80 |
| Sample 7 | 7.42 | 13.66 | 14.86 | 26.36 | 31.36 |
| Comp. Sample F | 8.15 | 9.37 | 10.21 | 9.04 | 7.36 |

Similarly to the results shown above, inclusion of a basic material resulted in the surprising and unexpected improved rate of deacetylation as compared to Comparative Samples D, E and F.

### Example 3

Samples were prepared as above, except that the basic material was embedded within a cigarette filter.

TABLE 5

| | Percent of Deacetylation (%) | | | | |
|---|---|---|---|---|---|
| | Material | Day 1 | Day 4 | Day 7 | Day 9 |
| Comp. | no material added, | 7.53 | 8.26 | 7.53 | 7.88 |
| Sample G | unsmoked | | | | |
| Sample 8 | Magnesium Oxide | 11.9 | 14.82 | 17.5 | 19.04 |
| | unsmoked | | | | |
| Sample 9 | Calcium Hydroxide | 88.32 | >100 | >100 | >100 |
| | unsmoked | | | | |
| Sample 10 | Calcium Oxide | >100 | >100 | >100 | >100 |
| | unsmoked | | | | |
| Comp. | no material added, | 6.73 | 8.07 | 8.00 | |
| Sample H | smoked | | | (Day 6) | |
| Sample 11 | Magnesium Oxide | 10.30 | 9.74 | 15.79 | |
| | smoked | | | (Day 6) | |
| Sample 12 | Calcium Hydroxide | 26.61 | 49.04 | 59.94 | |
| | smoked | | | (Day 6) | |
| Sample 13 | Calcium Oxide | 32.11 | 59.71 | 73.08 | |
| | smoked | | | (Day 6) | |

### Example 4

To test the total degradation, smoked cigarettes were provided, with the paper removed. The basic material was placed inside of the filter and then subjected to biodegradation. ISO 19679 (2016) was followed, except that river water was substituted for ocean water. The results are shown in FIG. 1, and show that calcium oxide and calcium hydroxide consumed nearly twice the carbon dioxide as when no basic material was included. The percentage of carbon dioxide consumed relative to cellulose, based on the slope of the line, was 82.39% for calcium hydroxide, 83.10% for calcium oxide, and 42.55% for the control without any basic material added.

### Illustrations

Illustration 1: A degradable cigarette filter comprising: a filter element comprising bloomed cellulose acetate tow, wherein the cellulose acetate has a degree of substitution (DS) of greater than 1.3; a catalyst comprising a basic material, an enzymatic material, or combination thereof; and a plug wrap at least partially surrounding the filter element; wherein the catalyst is incorporated into at least one of the filter element, the plug wrap, or combinations thereof, and wherein the catalyst, when exposed to water, deacetylates the bloomed cellulose acetate tow by at least 10% in 20 days or less.

Illustration 2: The filter of illustration 1, wherein the filter element comprises a plurality of particles dispersed throughout the tow, wherein the particles comprise the catalyst.

Illustration 3: The filter of illustration 2, wherein the particle size of the particles ranges from 500 nanometers to 800 microns.

Illustration 4: The filter of illustration 1, wherein the plug wrap comprises the catalyst.

Illustration 5: The filter of illustration 4, wherein the plug wrap is impregnated with the catalyst.

Illustration 6: The filter of any of illustrations 4-5, wherein the plug wrap is coated with the catalyst.

Illustration 7: The filter of illustration 1, wherein the filter element comprises a plurality of fibers impregnated with the catalyst, coated with the catalyst, or combinations thereof.

Illustration 8: The filter of illustration 7, wherein the fibers comprise comprises a polyvinyl alcohol, a cellulose ether, a polyethylene glycol, a polyvinyl acetate, a polyvinyl pyrrolidone, a polylactic acid, a polybutylene succinate, a polyhydroxyalkanoate, or combinations thereof.

Illustration 9: The filter of illustration 1, wherein the filter element comprises multiple segments and wherein at least one of the segments comprises the catalyst.

Illustration 10: The filter of illustration 9, wherein the filter has an encapsulated pressure drop of less than 3.5 mm water/mm length.

Illustration 11: The filter of any of illustrations 9-10, wherein the segment comprising the catalyst is in the shape of a hollow tube.

Illustration 12: The filter of any of illustrations 9-10, wherein the segment comprising the catalyst is in the shape of a ring.

Illustration 13: The filter of any of illustrations 9-10, wherein the segment comprising the catalyst is in the shape of a perforated disk.

Illustration 14: The filter of any of illustrations 9-13, wherein the segment comprising the catalyst is impregnated with the catalyst.

Illustration 15: The filter of any of illustrations 9-14, wherein the segment comprising the catalyst is coated with the catalyst.

Illustration 16: The filter of illustration 1, wherein the filter further comprises a hard shell encasing the filter element, wherein the hard shell comprises the catalyst.

Illustration 17: The filter of illustration 16, wherein the hard shell comprises a thin wall right circular cylinder split across the diameter of the face.

Illustration 18: The filter of any of illustrations 16-17, wherein the hard shell is impregnated with the catalyst.

Illustration 19: The filter of any of illustrations 16-18, wherein the hard shell is coated with the catalyst.

Illustration 20: The filter of any of any of the preceding illustrations, wherein the plug wrap comprises a polymeric film.

Illustration 21: The filter of illustration 20, wherein the polymeric film comprises a binder.

Illustration 22: The filter of any of illustrations 20-21, wherein the polymeric film comprises a plasticizer.

Illustration 23: The filter of any of illustrations 20-22, wherein the polymeric film comprises the catalyst.

Illustration 24: The filter of illustration 23, wherein the polymeric film is impregnated with the catalyst.

Illustration 25: The filter of any of illustrations 23-24, wherein the polymeric film is coated with the catalyst.

Illustration 26: The filter of any of the preceding illustrations, wherein the basic material has a pH of at least 7.4, preferably at least 7.6.

Illustration 27: The filter of any of the preceding illustrations, wherein the basic material comprises at least one of calcium oxide, calcium hydroxide, magnesium hydroxide, magnesium oxide, magnesium carbonate, basic aluminum oxide, or combinations thereof.

Illustration 28: The filter of any of the preceding illustrations, wherein the catalyst comprises a basic material and an enzymatic material, and wherein the enzymatic material comprises an esterase, a cellulase, a glucosidase, or combinations thereof.

Illustration 29: The filter of any of the preceding illustrations, wherein the enzymatic material comprises an esterase.

Illustration 30: The filter of any of the preceding illustrations, wherein the enzymatic material comprises an esterase and at least one of a cellulase, a glucosidase, or combinations thereof.

Illustration 31: The filter of any of the preceding illustrations, wherein the catalyst, when exposed to water, deacetylates the bloomed cellulose acetate tow by at least 20% in 20 days or less, preferably by at least 30%, more preferably by at least 60%.

Illustration 32: The filter of any of the preceding illustrations, wherein the at least one fiber is present in a ratio from 1:100 to 100:1 relative to a size of a cellulose acetate fiber.

Illustration 33: An aerosol-generating device comprising: an aerosol-generating article, wherein the aerosol-generating article comprises: an aerosol-forming substrate; a support element; an aerosol-cooling element; and a mouthpiece, wherein the mouthpiece comprises: a filter element comprising bloomed cellulose acetate tow, wherein the cellulose acetate has a degree of substitution (DS) of greater than 1.3; a catalyst comprising a basic material, an enzymatic material, or combination thereof; and a plug wrap at least partially surrounding the filter element, wherein the catalyst is incorporated into at least one of the filter element, the plug wrap, or combinations thereof, and wherein the catalyst, when exposed to water, deacetylates the bloomed cellulose acetate tow by at least 10% in 20 days or less.

Illustration 34: A tow bale comprising a plurality of cellulose acetate fibers and at least one fiber comprising a catalyst.

Illustration 35: The tow bale of Illustration 34, wherein the at least one fiber is formed from a water-soluble fiber.

Illustration 36: The tow bale of any of Illustrations 34-35, wherein the at least one fiber is formed from a polyvinyl alcohol, a cellulose ether, a polyethylene glycol, a polyvinyl acetate, a polyvinyl pyrrolidone, a polylactic acid, a polybutylene succinate, a polyhydroxyalkanoate, or combinations thereof.

Illustration 37: The tow bale of any of Illustrations 34-36, wherein the at least one fiber has a fiber size from 1 to 100 to 100 to 1 relative to the size of a single cellulose acetate fiber of the plurality of cellulose acetate fibers.

While the invention has been described in detail, modifications within the spirit and scope of the invention will be readily apparent to those of skill in the art. It should be understood that aspects of the invention and portions of various embodiments and various features recited above and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention.

We claim:

1. A degradable cigarette filter comprising:
a filter element comprising bloomed cellulose acetate tow, wherein the cellulose acetate has a degree of substitution (DS) of greater than 1.3;
a catalyst comprising a basic material, an enzymatic material, or combination thereof; and
a plug wrap at least partially surrounding the filter element;
wherein the catalyst is incorporated into at least one of the filter element, the plug wrap, or combinations thereof, and
wherein the catalyst, when exposed to water, deacetylates the bloomed cellulose acetate tow by at least 10% in 20 days or less.

2. The filter of claim 1, wherein the filter element comprises a plurality of particles dispersed throughout the tow and wherein the plurality of particles comprise the catalyst.

3. The filter of claim 2, wherein the particle size of the plurality of particles ranges from 500 nanometers to 800 microns.

4. The filter of claim 1, wherein the bloomed cellulose acetate comprises cellulose acetate fibers and at least one fiber impregnated with the catalyst, coated with the catalyst, or combinations thereof.

5. The filter of claim 4, wherein the at least one fiber comprises a polyvinyl alcohol, a cellulose ether, a polyethylene glycol, a polyvinyl acetate, a polyvinyl pyrrolidone, a polylactic acid, a polybutylene succinate, a polyhydroxyalkanoate, or combinations thereof.

6. The filter of claim 4, wherein the at least one fiber is present in a ratio from 1:100 to 100:1 relative to a size of a cellulose acetate fiber.

7. The filter of claim 1, wherein the filter element comprises multiple segments and wherein at least one of the segments comprises the catalyst.

8. The filter of claim 7, wherein the segment comprising the catalyst is in the shape of a hollow tube, a ring, or a perforated disk.

9. The filter of claim 8, wherein the segment comprising the catalyst is impregnated with the catalyst and/or coated with the catalyst.

10. The filter of claim 1, wherein the filter further comprises a hard shell encasing the filter element, wherein the hard shell comprises the catalyst.

11. The filter of claim 1, wherein the plug wrap comprises a polymeric film.

12. The filter of claim 11, wherein the polymeric film comprises a binder, a plasticizer, and/or the catalyst.

13. The filter of claim 1, wherein the basic material has a pH of at least 7.4.

14. The filter claim 1, wherein the basic material comprises at least one of calcium oxide, calcium hydroxide, magnesium hydroxide, magnesium oxide, magnesium carbonate, basic aluminum oxide, or combinations thereof.

15. The filter of claim 1, wherein the catalyst comprises a basic material and an enzymatic material, and wherein the enzymatic material comprises an esterase, a cellulase, a glucosidase, or combinations thereof.

16. The filter of claim 1, wherein the enzymatic material comprises an esterase.

17. The filter of claim 1, wherein the enzymatic material comprises an esterase and at least one of a cellulose, a glucosidase, or combinations thereof.

18. An aerosol-generating device comprising:
an aerosol-generating article, wherein the aerosol-generating article comprises:
an aerosol-forming substrate;
a support element;
an aerosol-cooling element; and
a mouthpiece,
wherein the mouthpiece comprises:
a degradable cigarette filter according to claim 1.

19. A tow bale comprising a plurality of cellulose acetate fibers and at least one fiber comprising a catalyst.

20. The tow bale of claim 19, wherein the at least one fiber is formed from a polyvinyl alcohol, a cellulose ether, a polyethylene glycol, a polyvinyl acetate, a polyvinyl pyrrolidone, a polylactic acid, a polybutylene succinate, a polyhydroxyalkanoate, or combinations thereof.
